(19) United States
(12) Patent Application Publication
(10) Pub. No.: US 2016/0077057 A1
(43) Pub. Date: Mar. 17, 2016

(54) GRADED STRUCTURE FILMS

(71) Applicant: Empire Technology Development LLC, Wilmington, DE (US)

(72) Inventor: Yasuhisa FUJII, Kyoto (JP)

(21) Appl. No.: 14/784,535

(22) PCT Filed: Apr. 16, 2013
(86) PCT No.: PCT/US2013/036812

§ 371 Date: Oct. 14, 2015

(51) Int. Cl. G01N 29/22

(52) U.S. Cl. CPC G01N 29/22

(57) ABSTRACT

Devices, films, and methods for the detection of target molecules are provided. The devices, films and methods can include graded layers and a vibration detecting unit. The vibration detecting unit can be a convex or an inverse mesa vibration detecting unit.

### TECHNICAL FIELD

Some embodiments herein generally relate to apparatus and methods for detection.

### BACKGROUND

A variety of devices and methods exist for sensing chemicals in the environment. In some situations, the methods and/or devices employ various films for the physical aspect of the detection in these sensing devices. Such films can be created in a number of ways, such as ink-jet printing, dispensing, spin coating, dipping, etc.

### SUMMARY

In some embodiments, methods and devices are provided for detecting the presence or absence of molecules in the environment.

In some embodiments, a sensor device is provided. The sensor device can include at least one vibration detecting unit, a conductive layer, and a sensitive film. The vibration detecting unit can have a shape that is convex or an inverse mesa. In some embodiments, two or more vibration detecting units can form an array. In some embodiments, the sensitive film can be graded such that it varies in thickness. In some embodiments, the sensor device includes two or more overlapping graded sensitive films.

In some embodiments, a method of detecting a presence or an absence of a target is provided. The method can include providing a sensor having a graded sensitive film and a convex vibration detecting unit and/or an inverse mesa detecting unit. In some embodiments, the method includes contacting the sensitive film with a volume of material in which a presence of a target or an absence of the target is to be detected. The presence of the target results in the target changing a vibrational frequency of the sensitive film, which can be detected by the vibration detecting unit. In some embodiments, interference between vibration detecting units is reduced by the presence of at least one of the convex vibration detecting unit or the inverse mesa shaped vibration detecting unit.

In some embodiments, a method of making a sensor is provided. The method can include providing at least one of a convex vibration detecting unit or an inverse mesa shaped vibration detecting unit, providing a sensitive film having a graded thickness, coupling the sensitive film to the vibration detecting unit, providing a conductive film, and coupling the conductive film to the vibration detecting unit, such that a change in mass of the sensitive film is detectable by the vibration detecting unit. The vibration detecting unit can provide an electrical signal to the conductive film. This signal can indicate the change in mass and thus, the association of a relevant molecule to the sensitive film.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a drawing depicting some embodiments of a sensor device including a graded sensitive film and a vibration detecting unit.

FIG. 2A is a drawing depicting some embodiments of a convex vibration detecting unit.

FIG. 2B is a drawing depicting some embodiments of an array of inverse mesa vibration detecting units.

FIG. 3 is a flowchart depicting some embodiments of a method for detecting the presence or absence of a target using the sensor device provided herein.

FIG. 4A is a drawing depicting some embodiments of a graded sensitive film.

FIG. 4B is a drawing depicting some embodiments of a graded sensitive film.

FIG. 4C is a drawing depicting some embodiments of overlapping graded sensitive films.

FIG. 5A is a drawing depicting some embodiments of the surface of a sensor device having a plurality of detecting sites.

FIG. 5B is a drawing depicting some embodiments of the optional placement of the vibration detecting units under the detection sites noted in FIG. 5A.

FIG. 6 is a drawing depicting some embodiments of a system for manufacturing a graded film.

FIG. 7A is a flowchart depicting some embodiments of a method of manufacturing a sensor device.

FIG. 7B is a drawing depicting some embodiments of a method of providing a sensitive film.

FIGS. 8A-8E are drawings depicting cross-section views of various embodiments of convex vibration detection units, such as QCMs.

FIG. 9 is a drawing depicting various embodiments of cut crystal.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

Provided herein are embodiments that can be employed in the detection of target molecules, such as various chemicals in fluids. This can be achieved by one or more graded sensitive layers that can be part of a sensor device. The graded sensitive layer selectively interacts with the molecules, which changes the mass of the local environment of the sensitive layer. This change in mass can be detected by a vibration detecting unit, which provides an electrical signal in response to the change in mass. As outlined herein, there are a variety of vibration detecting units, including convex vibration detecting units and inverse mesa vibration detecting units, which can provide benefits for such sensing technologies. Thus, provided herein are embodiments relating to the combination of various vibration detecting units and graded sensitive layers.

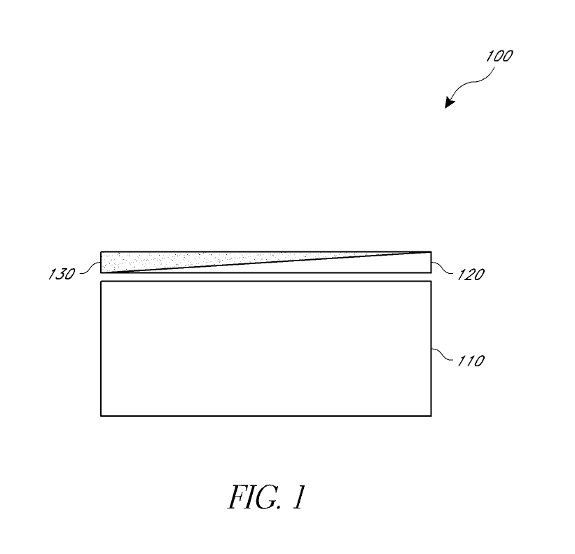

FIG. 1 depicts some embodiments of a sensor device including a vibration detecting unit and a graded sensitive film. The sensor device 100 can include at least one vibration detecting unit 110, a conductive layer (not shown), and a sensitive film 120, 130. The sensitive film can be associated with the vibration detecting unit, and the conductive layer is associated with the vibration detecting unit. In some embodiments, the sensitive film can be effectively associated with the conductive layer via the vibration detecting unit. The presence of a target to be detected can change a mass of the sensitive film by effectively binding to or being absorbed into the film. This change in mass results in a change in vibrational frequency which can be detected by the vibration detecting unit. This information is then transmitted out of the array for processing. In some embodiments, the information can be transmitted by the conductive layer. In some embodiments, the conductive layer also (or alternatively) supplies energy to the system to establish a basal vibration level. Thus, in some embodiments, the presence (or absence) of a target can be detected by a measured change in vibrational frequency of the sensitive film or a component in physical contact with the sensitive film (such as quartz, which can make up the substrate and/or vibration detecting unit).

It has been appreciated that specific types of vibration detecting units, when combined with graded sensitive films, provide for devices, systems, and/or methods with various properties. Thus, in some embodiments, the sensor device can include one or more vibration detecting units. While in some embodiments, the vibration detecting units 110 can have any shape suitable for detecting a vibration, in some embodiments, the vibration detecting unit includes a convex shape. In some embodiments, the vibration detecting unit includes an inverse mesa shape (for example, include a recessed surface). These aspects are discussed in more detail below.

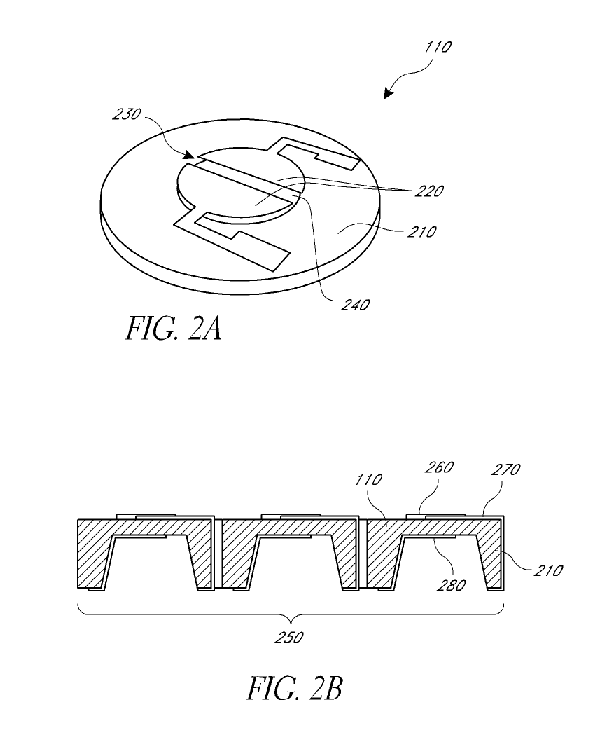

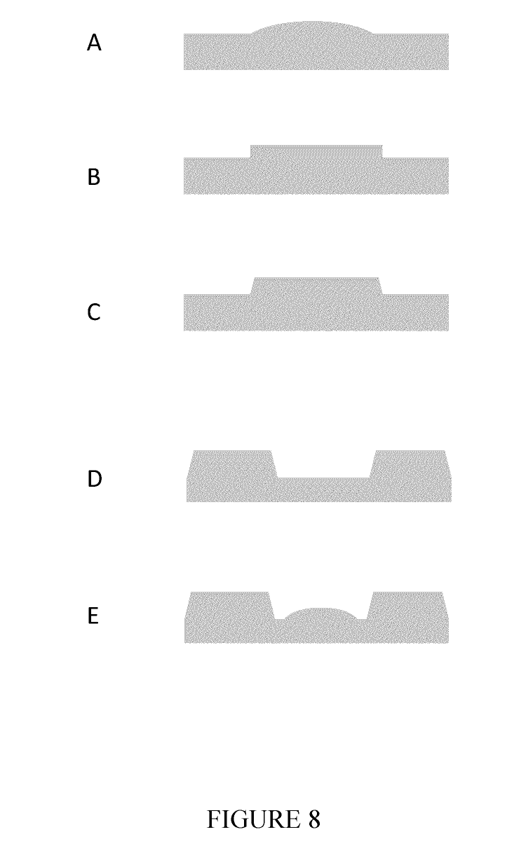

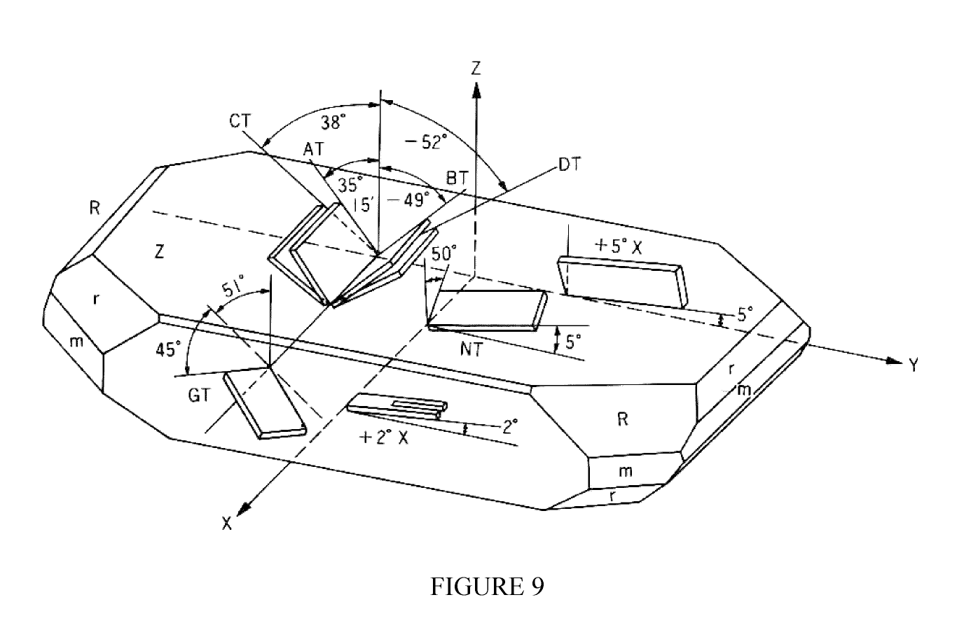

FIG. 2A depicts some embodiments of a vibration detecting unit 110 having a convex shape. The support 210 of the vibration detecting unit can be made of a variety of materials. The vibration detecting unit can include one or more excitation electrodes 220, on the support, which, through the application of an electrical potential, can establish the basal vibrational frequency of the system when in use. When these electrodes 220 are on the same side, there can be a gap 230 between them. In some embodiments, there can be a conductive film 240 that can be on the opposite side of the image shown in FIG. 2A. In addition to the embodiments in FIG. 2A, FIGS. 8A-8E depict additional embodiments for the convex vibration detection unit. In some embodiments, the vibration detecting unit is an integral part of a substrate. That is, in some embodiments, the vibration detection unit can be made from the substrate or be a part of the substrate.

In some embodiments, the convex shape of the vibration detecting unit can include one or more surfaces that are curved. In some embodiments, the convex shape can include one or more surfaces that are rounded in an outward direction. In some embodiments, the one or more surfaces can include a raised portion to effectively provide the convex shape.

In some embodiments, the convex vibration detecting unit can be a quartz crystal microbalance (QCM). In some embodiments, the convex vibration detecting unit can be a plano-convex QCM. In some embodiments, the convex vibration detecting unit can be a bi-convex QCM. In some embodiments, the convex QCM can be any one of those depicted in FIGS. 8A-8E.

In some embodiments, the support for the convex vibration detecting unit can include AT-cut crystal (as shown in FIG. 9) In some embodiments, the quartz substrate can be a CT-cut, BT-cut, DT-cut, NT-cut, GT-cut crystal, or any other cut (for example, as shown in FIG. 9). In some embodiments, the convex vibration detecting unit can be miniaturized.

While two electrodes 220 are shown on the same side of the support 210 in FIG. 2A, in some embodiments, each side of the support 210 can have one of the electrodes, thereby removing any need for a gap 230.

As noted above, in some embodiments, the vibration detecting unit can be in an inverse-mesa shape. FIG. 2B depicts some embodiments of an array 250 of vibration detecting unit 110 that include an inverse mesa shape. One or more electrodes 260, 270, and 280 can be associated with the support of the vibration detecting unit. In some embodiments, the excitation electrodes 270 and 280 can be located on opposite sides of the support 210. In some embodiments, a conductive layer 260 can be positioned as part of the vibration detection unit.

In some embodiments, the inverse mesa shape can include a groove within the substrate (and thus, be made of the substrate). In some embodiments, the groove can form a section of relative thinness in the substrate. In some embodiments, the inverse mesa (or walls of the groove) is made from the quartz substrate by etching a groove into the substrate. Thus, in some embodiments, the quartz substrate will be thinner in some sections relative to others. In some embodiments, electrodes can be formed on both sides of the thinner section of the inverse mesa. In some embodiments, the electrode portion of the thin crystal can be part of the sensor, with one or more additional graded layers (120, 130 in FIG. 1) being positioned over this thinner section.

The vibration detecting unit can include a support 210. In some embodiments, the support can be the same structure as the substrate upon which the vibration detecting unit is located. Thus, in some embodiments, the vibration detecting unit is integral to the substrate. In some embodiments, the support 210 of the vibration detecting unit can be different and/or separate from the substrate.

In some embodiments, the vibration detecting unit can be formed on top of the substrate. In some embodiments, the substrate can have any suitable shape. In some embodiments, the substrate can be a triangle, square, pentagon, hexagon, octagon, circle, oval, etc.

In some embodiments, the support has a thickness of 0.1 micron or more, for example, 0.1, 1, 10, 20, 30, 40, 50, 60, 70, 80, 90, 100, 1000, 10,000 microns or more, including any range between any two of the preceding values and any range above any one of the preceding values.

In some embodiments, the support can be made of any material capable of experiencing a frequency of oscillation. In some embodiments, the support can experience a piezoelectric effect. In some embodiments, the support is composed of quartz. In some embodiments, the support is substantially all quartz or the support is quartz. In some embodiments, the support can include a ceramic such as lithium niobate, potassium niobate, PZT (lead zirconate titanate), barium titanate, langasite, etc.

In some embodiments, the vibration detecting unit can also include one or more conductive layers 220, 260, 270, 280. In some embodiments, the conductive layer can be made of any conductive material. In some embodiments, the conductive layer includes gold, copper, silver, platinum, chromium, and/or conductive polymers. In some embodiments, the thickness can be between about 0.01 microns to about 1 micron, for example about 0.05 microns to about 0.3 microns.

The conductive layer can be located on one or more surfaces of the support. In some embodiments, the conductive layer is on a top surface of the support. In some embodiments, the conductive layer is on a bottom surface of the support. In some embodiments, the conductive layer is on the top and bottom surface of the support.

In some embodiments, the conductive layer serves as at least one electrode. In some embodiments, the conductive layer includes two or more electrodes. In some embodiments, the electrode can be an excitation electrode to generate the basal level of vibration in the support and/or quartz. In some embodiments, the excitation electrode can include a separated electrode that has an electrode gap 230 between the two parts of the electrode. In some embodiments, the excitation electrode is a non-separated electrode. In some embodiments, a conductive film is on a top surface of the support and an excitation electrode is on a bottom surface of the support. In some embodiments, a conductive film is on a bottom surface of the support and an excitation electrode is on a top surface of the support. In some embodiments, the two separate electrodes are located on the same side of the vibration detecting unit. In some embodiments, the two separate electrodes are located on a bottom surface of the support.

In some embodiments, the sensor device can include two or more vibration detecting units. In some embodiments, the sensor device can include a plurality of vibration detecting units. For example, a plurality of vibration detecting units can be arranged in an array. The vibration detecting units can be arranged in any suitable configuration. In some embodiments, the vibration detecting units are spaced equal distance from one another. In some embodiments, the arrangement of the plurality of vibration detecting units is arbitrary and/or random. In some embodiments, the vibration detecting units form one or more arrays of vibration detecting units, such as 250. In some embodiments, the vibration detecting units are spaced apart as a function of the gradient change in the sensitive film. Thus, for example, the vibration detecting units are spaced so that meaningful changes in the amount of material of the sensitive film can be detected by a proximal vibration detecting unit. In some embodiments, the vibration detecting units are positioned so that fine changes can be observed. In some embodiments, the vibration detecting units are positioned so that a majority of the film above a vibration detecting unit is for detecting a single molecule species. Thus, a change in signal for the vibration detecting unit will indicate the presence of the target species that is absorbed by the film above the vibration detecting unit. In some embodiments, the vibration detecting units are positioned under sections of gradients of the film, such that a single vibration detecting unit can detect absorption in two or more gradient films (for example, 2, 3, 4, 5, 6, 7, 8, 9, 10 or more films). In such arrangements, the patterns of signals from the array can indicate what molecule species are binding to the film, as a single change in signal from a vibration detecting unit can indicate the presence (or absence) of any molecule that can absorb to the stack of sensitive film above it.

In some embodiments, vibration detecting units can be spaced 10⁻⁹, 10⁻⁸, 10⁻⁷, 10⁻⁶, 10⁻⁵, 10⁻⁴, 10⁻³, 10⁻², 10⁻¹, or 1 meter apart from one another, including any range between any two of the preceding values and any range above any one of the preceding values.

In some embodiments, the top surface of the first vibration detecting unit is in a same plane as the top surface of an adjacent vibration detecting unit. In some embodiments, substantially all of the surfaces of the vibration detecting units are in approximately the same plane.

In some embodiments, the array can include all the same type of vibration detecting units, for example, all convex vibration detecting units or all inverse mesa vibration detecting units. In some embodiments, the array can include convex vibration detecting units and inverse mesa vibration detecting units.

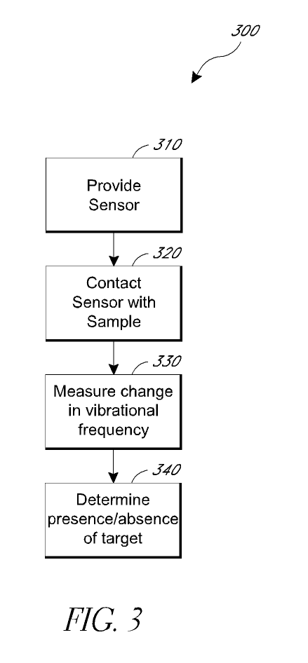

FIG. 3 depicts some embodiments of a method (300) for detecting the presence or absence of a target using the sensor device provided herein.

The various devices and components provided herein can be employed for a variety of methods. In some embodiments, the method of detecting a presence or an absence of a target includes providing a sensor (block 310). In some embodiments, the sensor can include a sensitive film and a vibration detecting unit. The method can include contacting the sensor with a sample (block 320), which can be achieved in any number of ways, for example, flowing a sample that may include a target over a surface of the sensor. In some embodiments, the method includes measuring a change in vibrational frequency (block 330). In some embodiments, this is achieved by applying an electrical charge to the excitation electrode while the sensor is in a vacuum and measuring a baseline vibrational frequency in the absence of a target. In some embodiments, a background environment can be taken into account, and thus, an initial baseline vibrational frequency is determined in an operating environment (or where the sensitive film is under standardized conditions). One can then determine the presence or absence of a target in the sample (block 340). One can achieve this by detecting any change in vibrational frequency. For example, a decrease in vibrational frequency can indicate an increase in mass, and thus, an increase in binding to the sensitive film, which is indicative of the presence and/or increase of a target molecule. Similarly, an increase in vibrational frequency can indicate a decrease in mass, and thus, a decrease in binding to the sensitive film, which is indicative of the absence and/or decrease of a target molecule. As noted above, an array of vibration detecting units can be used to detect more than one target and/or detect various concentrations of a target molecule.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

The sensor device can be used in any suitable environment. In some embodiments, the sensor device can be used under vacuum. In some embodiments, the method and/or device can be employed with a fluid, such as a gas or a liquid.

In some embodiments, a sample can be provided to the sensor device by bringing the sample to a surface of the sensitive film. In some embodiments, the sample is flowed across a surface of the sensitive film. In some embodiments, the sample is placed on the sensitive film, allowed to sit and then removed. In some embodiments a brief washing process can be performed between the application of the sample to the surface of the sensitive film to the measuring of a change in vibrational frequency. This can allow for one to reduce any effect of nonspecific binding.

In some embodiments, the change in vibrational frequency is determined while a sample is being moved across a surface of the sensitive film. In such arrangements, the background vibrational frequency can take into account the impact of the sample presence and/or movement on the vibrational frequency. In some embodiments, the change in vibrational frequency is determined while there is no sample movement across a surface of the sensitive film. In some embodiments, the change in vibrational frequency is determined while there is no sample on a surface of the sensitive film, and thus, the sample is removed and any target detected is that which remains after the removal of the bulk sample.

In some embodiments, the device and/or method is maintained at a consistent and/or constant temperature, as crystal oscillators can be sensitive to changes in temperature. Thus, in some embodiments, the method occurs at a similar temperature throughout the method.

In some embodiments, the volume of the sample is at least 10⁻⁹, 10⁻⁸, 10⁻⁷, 10⁻⁶, 10⁻⁵, 10⁻⁴, 10⁻³, 10⁻², 10⁻¹, 1, 10, 10², 10³, 10⁴, 10⁵, 10⁶ liters or more, including any range above any one of the preceding values and any range between any two of the preceding values. In some embodiments, any flow rate can be used to apply the sample to the surface of the sensitive film. In some embodiments, the flow rate of the sample is at least 10⁻⁹, 10⁻⁸, 10⁻⁷, 10⁻⁶, 10⁻⁵, 10⁻⁴, 10⁻³, 10⁻², 10⁻¹, 1, 10, 10², 10³, 10⁴, 10⁵, 10⁶ liters/minute or more, including any range above any one of the preceding values and any range between any two of the preceding values.

In some embodiments, the sample can include one or more target. In some embodiments the target can be any material capable of interacting with the sensitive film. In some embodiments, the target can be a gas component. In some embodiments, the target can include at least one of ammonia, hydrogen, methane, hydrogen sulfide, and/or carbon dioxide. In some embodiments, the target can include at least one or more component of flatus odor, and thus be used for a sensor of flatus odor. In some embodiments, the target can include any component in a fluid-based diagnosis.

In some embodiments, the sensitive film can be selected based upon the target or targets that one desires to detect the presence and/or absence of. Thus, in some embodiments, any sensitive film can be used as long as it absorbs the target molecule. In some embodiments, the sensitive film directly absorbs the target molecule. In some embodiments, the sensitive film is associated with an agent that binds the target molecule. In some embodiments, the sensitive film selectively binds and/or absorbs the target molecule. In some embodiments, selectively denotes that the film absorbs more of the target (and/or absorbs it more quickly and/or retains the target better) than at least one other molecule species in a sample and/or in a standardized control sample. In some embodiments, any amount of superior binding and/or absorption is sufficient, for example, 1, 10, 100, 1000, 10,000, 100,000, or 1,000,000 percent better binding and/or absorption, including any range above any one of the preceding values and any range between any two of the preceding values.

In some embodiments, the film can include acrylic acid. In some embodiments, ammonia can associate with a film including acrylic acid, and thus, acrylic acid can be used to detect ammonia. In some embodiments, the film can include palladium. In some embodiments, hydrogen can associate with a film including palladium, and thus, palladium can be used to detect hydrogen. In some embodiments, the film can include zinc oxide. In some embodiments, hydrogen sulfide can associate with a film including zinc oxide. In some embodiments, the film can include titanium dioxide. In some embodiments, carbon dioxide can associate with a film including titanium dioxide.

The sensitive film can be made of any material suitable for associating with a target. In some embodiments, the material (or composition) of the sensitive can be selected based on any number of parameters, for example, the polarity, dielectric constant, dissolution parameter, hydrophilicity, hydrophobicity, charge, and/or conductivity of the material. In some embodiments, the sensitive film selectively responds to a target.

In some embodiments, the sample includes two or more targets for example, 2, 3, 4, 5, 6, 7, 8, 9, 10, 20, 30 or more targets, including any range above any one of the preceding values and any range defined between any two of the preceding values. In some embodiments, the second target can be the same or substantially the same as the first target. In some embodiments, the second target can be different than the first target.

In some embodiments, the vibration detecting unit can measure a mass per unit area by measuring a change in frequency of the support and/or sensitive film. In some embodiments, the resonance can be altered by the addition or removal of a mass at or near a surface of the sensitive film. In some embodiments, changes in frequency can be determined to a high precision by measuring the mass densities down to a level of below 10,000 μg/cm², for example 10,000, 1000, 100, 10, 1, 0.1, 0.01, or 0.001 μg/cm², including any range beneath any one of the preceding values and any range between any two of the preceding values.

In some embodiments, the vibration detecting units can produce a basal standing wave via the application of an alternating current to the excitation electrodes of the support. This can induce oscillations in the form of a standing shear wave. In some embodiments, the vibration detecting unit can detect the basal standing wave. In some embodiments, the vibration detecting unit can detect a change in the basal standing wave.

In some embodiments, the Q factor, which is the ratio of frequency and bandwidth, can be as high as 106 to 1. In some embodiments, the Q value is more than 5000, for example 5000, 10,000, 50,000, 100,000, 150,000 200,000 or greater, including any amount above any of the preceding values or between any two of the preceding values. Such a narrow resonance leads to highly stable oscillators and a high accuracy in the determination of the resonance frequency. Thus, in some embodiments, common equipment allows for resolution down to 1 Hz on crystals with a fundamental resonant frequency in the 9 MHz range. The frequency of oscillation of the vibration detecting unit is partially dependent on the thickness of the support and/or the sensitive films over the support. Where the other influencing variables remain constant, a change in mass of the support and/or sensitive film will correlate to a change in frequency.

In addition to measuring the frequency, in some embodiments, the dissipation can be measured to help analysis. The dissipation is a parameter quantifying the damping in the system, and is related to the sample's viscoelastic properties. The dissipation is equal to the ratio of bandwidth, and frequency.

In some embodiments, this frequency change can be quantified and correlated to the change in mass. In some embodiments, the presence of a target can be determined by a change (decrease) in the vibrational frequency. In some embodiments, the absence can be determined by a lack of change in vibrational frequency (or an increase in vibrational frequency).

Any of a number of various techniques can be used for measuring to quantify and/or correlate the mass change. In some embodiments, techniques can include, but are not limited to, Sauerbrey's equation, Ellipsometry, Surface Plasmon Resonance (SPR) Spectroscopy, and/or Dual Polarisation Interferometry.

In some embodiments, the change in frequency correlating to the amount of a target associated with a sensitive film can be solved by employing Equation I:

Δf=2f₀²m_{f}/A(ρ_{q}μ_{q})^{1/2} Equation I
Δf: Change in resonant frequency
f₀: Resonant frequency
ρ_{q}: support density (for example Quartz 2.65 g/cm³)
μ_{q}: Frequency constant 1.67*10⁵ cmHz
m_{f}: Change in mass due to association of target
A: Electrode area
f₀ (MHz)=1670/t
t=thickness of support (μm)

In some embodiments, the relationship between an amount of target in a sample and the change in mass and/or change in frequency can be determined by correlating known controls, for example, samples with a known amount of one or more targets in the sample, with a specific change in mass and/or change in frequency. In some embodiments, the change in electrical signal from the vibration detecting unit can be correlated to a specific amount of a target and/or range of a target in a sample by comparing known controls with a specific change in electrical signal from the vibration detecting unit.

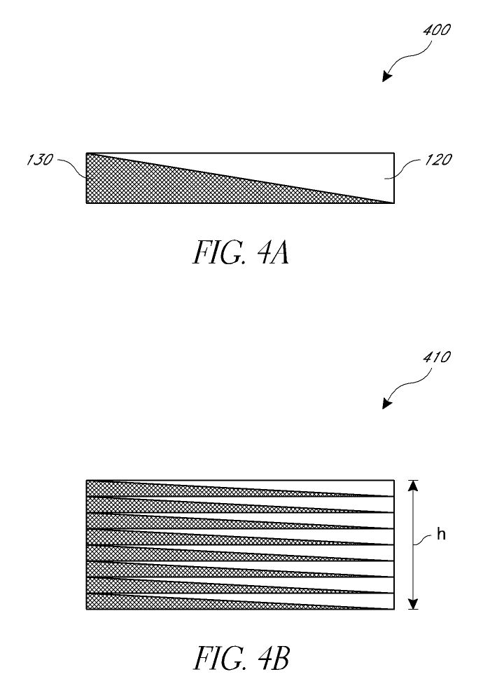

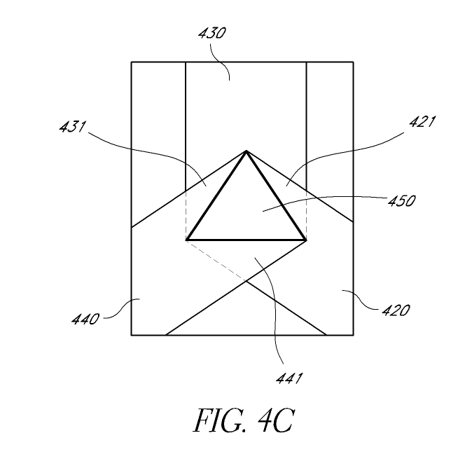

FIGS. 4A-4B depict some embodiments of a graded sensitive film. FIG. 4A depicts a first graded sensitive film 120 at least partially overlaying a second graded sensitive film 130. In some embodiments, one or more such film can be present over and/or associated with the vibration detecting unit. In some embodiments, only one of the films is present over any one vibration detecting unit. In some embodiments, more than two such films are present. As shown in FIG. 4B, in some embodiments, a stack of such films can be provided to a height “h”, so as to provide for additional layers of the sensitive film, where the height of a single layer is not sufficient, and/or where overlapping layers are desired to increase the density of the sensing areas on a device. Given the various properties of some of the embodiments of the vibration detecting units, such a graded approach can allow for the benefits of a further reduction in size, while maintaining, for example, good separation between the vibration detecting units.

In some embodiments, the sensor device can include one or more sensitive films. In some embodiments, the one or more sensitive films can be graded. In some embodiments, the sensitive film can change or progress in thickness across the surface of a substrate and/or electrode, and/or part of the vibration detecting unit. In some embodiments, the sensitive film changes in gradient across a quartz substrate. In some embodiments, the sensitive film can have a linear slope, but need not be linear in all embodiments. The sensitive film can vary in thickness from a first end to a second end. In some embodiment, the change in thickness can be gradual.

In some embodiments, the sensitive film can have a thickness of about 0.1 nm to about 1,000,000 nm. In some embodiments, the sensitive film has a thickness of about 1,000,000, 100,000, 10,000, 1,000, 100, 10, 1, or 0.1 nm, including any range above any one of the preceding values and any range defined between any two of the preceding values. In some embodiments, the sensitive film has a maximum thickness of about 5 nm.

The sensitive film can be configured to associate with the target molecule. In some embodiments, the sensitive film can absorb the target molecule, or at least associate sufficiently with the target molecule such that the mass of the sensitive film is altered.

In some embodiments, the sensitive film is located over the vibration detecting unit. In some embodiments, the sensitive film can be above, have a common end point, and/or have a common border with the vibration detecting unit. In some embodiments, the sensitive film is adjacent to the vibration detecting unit. In some embodiments, the sensitive film contacts the vibration detecting unit. In some embodiments, the sensitive film adjoins, is contiguous with, and/or is juxtaposed to the vibration detecting unit. In some embodiments, the sensitive film is in close proximity to but does not contact the vibration detecting unit. In some embodiments, the sensitive film has an interface with the vibration detecting unit and/or the conductive film.

In some embodiments, the sensitive film is placed on the vibration detecting unit directly or indirectly. In some embodiments, the sensitive film is over the conductive layer. In some embodiments, the sensitive film is over the substrate. In some embodiments, one or more intervening layers can be located between the sensitive film and the vibration detecting unit.

In some embodiments, a mass of the sensitive film is distributed substantially at a middle portion the vibration detecting unit. In some embodiments, the sensitive film is at least partially overlaying a portion of the vibration detecting unit. The sensitive film can be physically coupled to the vibration detecting unit such that changes in the mass of the film can be detected by the vibration detecting unit.

In some embodiments, the sensor device can include two or more sensitive films, for example, 2, 3, 4, 5, 6, 7, 8, 9, 10, 20, 30 or more films, including any range above any one of the preceding values and any range defined between any two of the preceding values. In some embodiments, the second sensitive film can have the same composition as the first sensitive film. In some embodiments, the second sensitive film can have a different composition from the first sensitive film. In some embodiments, the two or more sensitive films can alternate in composition. For example, in some embodiments, a subsequent sensitive film can have the same composition as the first sensitive film, while the second sensitive film can have a different composition than the first and the subsequent sensitive film.

In some embodiments, one or more of the sensitive films can be graded. In some embodiments, the first and second sensitive films can have the same or substantially the same gradient. In some embodiments, the first and second sensitive films can have different gradients. In some embodiments, the first and second sensitive films overlap at their graded areas (for example, as shown in the middle section of FIG. 1, wherein 120 and 130 overlap). Such an overlap allows for numerous layers to be positioned in a smaller area, and still be monitored by vibration detecting units (such as 110).

In some embodiments, the first sensitive film includes acrylic acid, the second sensitive film includes palladium, and the third sensitive film includes zinc oxide.

In some embodiments, at least a portion of each of the two or more sensitive films can overlap one another. In some embodiments, the two or more sensitive films substantially overlap one another. In some embodiments, the two or more sensitive films overlap one another in an area over a vibration detecting unit.

In some embodiments, the two or more overlapping sensitive films have a maximum thickness, h, of about 1,000,000 nm or less, for example, 1,000,000, 100,000, 10,000, 1,000, 500, 200, 190, 180, 170, 160, 155, 150, 145, 140, 135, 130, 120, 100, 50, 25, 10, 5, or 1 nm, including any range below any one of the preceding values and any range defined between any two of the preceding values.

In some embodiments, more than two graded layers can overlap one another (for example, as shown in FIG. 4C). FIG. 4C illustrates a graded-composition film structure formed by a first sensitive film 430, a second sensitive film 440, and a third sensitive film 420. As each of the films 420, 430, and 440 are graded, the center section 450, can include a configuration in which all three films overlap to varying degrees. Furthermore, there are also areas in which only two of the graded films overlap, for example, section 421 is a mixture of 420 and 430; 431 is a mixture of 430 and 440; and 441 is a mixture of 440 and 420. Furthermore, sections 430, 440, and 420 can represent section of pure sensitive films for detecting a specific target. Alternatively, the overlapping of films shown in the middle of FIG. 4C can be continued in the other sections of those films. Thus, by employing a graded arrangement, one can create numerous, different, sensing areas within a very small area. The overlapping and/or graded arrangement allows for greater compression of the sensing surface as well as advantages of combinatorial combinations. In some embodiments, the graded-composition film structure has an equilateral triangle shape; however, it need not be limited in this regard. Furthermore, the shape is a feature of the number of graded films employed and the relative angle of each strip that is applied. In some embodiments, at least a portion of each of the two or more sensitive films can overlap one another to form a graded composition structure. In some embodiments, the graded sensitive film does not overlap another graded sensitive film or another non-graded sensitive film.

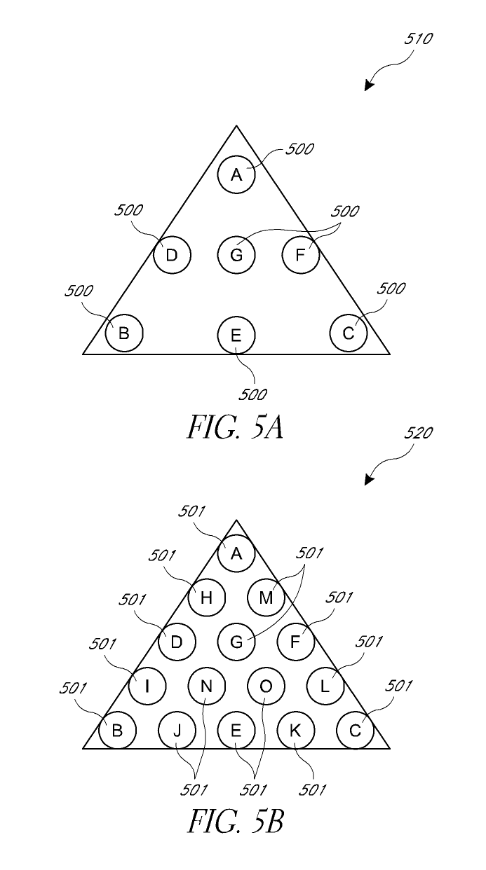

FIGS. 5A-5B are drawings depicting some embodiments of arrangements of a device having a plurality of detection sites.

FIG. 5A illustrates some embodiments of a graded composition film structure 510 including three sensitive films and including at least seven detection sites 500 (detection sites identified as A-G). For the purposes of an example only, this arrangement can be mapped onto the graded film shown in FIG. 4C, as section 450. In such an embodiment, detection site A includes a sensitive film composed of substantially 100% the first sensitive film 430 (as the graded structure results in an arrangement in which nearly all, if not all, of the film is from film 430. Similarly, detection site B includes a sensitive film composed of substantially 100% the second sensitive film 440. Similarly, detection site C includes a sensitive film composed of substantially 100% the third sensitive film 420.

In contrast, detection site D includes a sensitive film composed of the first sensitive film 430 and the second sensitive film 440. In some embodiments, detection site D has a ratio of 1:1 the first sensitive film 430 and the second sensitive film 440. Other ratios are also possible, simply by varying the slope of the graded film and/or relative thickness of the films.

Detection site E includes a sensitive film composed of the second sensitive film 440 and the third sensitive film 420. In some embodiments, detection site E has a ratio of 1:1 the second sensitive film 440 and the first sensitive film 420. Other ratios are also possible, simply by varying the slope of the graded film and/or relative thickness of the films.

Detection site F includes a sensitive film composed of the first sensitive film 430 and the third sensitive film 420. In some embodiments, detection site F has a ratio of 1:1 the first sensitive film 430 and the third sensitive film 420. Other ratios are also possible, simply by varying the slope of the graded film and/or relative thickness of the films.

Detection site G includes a sensitive film composed of the first sensitive film 430, the second sensitive film 440, and the third sensitive film 420. In some embodiments, detection site G has a ratio of 1:1:1 the first sensitive film 430, the second sensitive film 440, and the third sensitive film 420. Other ratios are also possible, simply by varying the slope of the graded film and/or relative thickness of the films.

The vibration detecting units 501 can then be positioned under the various detection sites 500, in any number of arrangements. FIG. 5B illustrates some embodiments of how to arrange such vibration detecting units 501 given some of the aspects noted in FIG. 5A. The vibration detecting units 501 can be positioned directly under the detection sites, such as vibration detection unit A (placed proximally to detection site 500, A); vibration detection unit B (placed proximally to detection site 500, B); vibration detection unit C (placed proximally to detection site 500, C); vibration detection unit D (placed proximally to detection site 500, D); vibration detection unit E (placed proximally to detection site 500, E); vibration detection unit F (placed proximally to detection site 500, F); and vibration detection unit G (placed proximally to detection site 500, G). Such an arrangement will allow for the most direct sensing of a change in mass to the film located above the vibration detecting unit. As, such, the change in mass of the above noted ratios for these detection sites can be directly monitored. In addition to directly monitoring these identified detection sites, there are also benefits for monitoring the sites between those sites specifically identified in FIG. 5A. Placing a vibration detecting unit between such sites allows one to monitor activity either between the sites, which can have a different gradient (or even additional films in some embodiments). In addition, or alternatively, placing a vibration detecting unit between units can allow for additional data to be gathered when two or more other detection sites experience a change in mass. Thus, in some embodiments, the arrangement can provide superior detection precision.

In some embodiments, each detection site can be monitored by a vibration detecting unit that sends an electrical signal for further processing. In some embodiments, the source of the signal (which vibration detecting unit the signal came from) is monitored and/or can be determined In some embodiments, for example where it is not important which sensitive film had a change in mass due to a target, the source of the signal need not be monitored and/or recorded and/or determined

In some embodiments, the sensor device can include two or more detection sites, for example, 2, 3, 4, 5, 6, 7, 8, 9, 10, 20, 30, 40, 50, 60, 70, 80, 90, 100 or more detection sites, including any range above any one of the preceding values and any range defined between any two of the preceding values. In some embodiments, the second detection site can be the same or substantially the same as the first detection site. In some embodiments, the second detection site can have the same sensitive film composition as the first detection site. In some embodiments, the second detection site can have a different sensitive film composition than the first detection site. In some embodiments, the second detection site can have the same type of vibration detecting unit as the first detection site. In some embodiments, the second detection site can have a different vibration detecting unit than the first detection site.

In some embodiments, the two or more detection sites can be located on a graded composition film structure, such as 450. As will be appreciated by one of skill in the art, given the present disclosure, by increasing the number of vibration detecting units in the substrate, it becomes possible to use a graded-composition film structure having a more finely graded composition. The vibration detecting units (or detection sites) can be in any suitable arrangement.

In some embodiments, the sensor device is configured to detect the presence or absence of each of two or more targets. In some embodiments, the second detection site is configured to detect the presence or absence of a second target. In some embodiments, a detection site will only bind and/or absorb one target molecule. In some embodiments, a detection site can bind and/or absorb more than one target molecule. In some embodiments, a detection site can bind and/or absorb a class of molecules selectively over other detection sites.

As the distance between vibration detecting units decreases negative effects due to interference between vibration detecting units can occur. As will be appreciated by one of skill in the art, given the present disclosure, the various vibration detection units provided herein can reduce interference between the vibration detecting units. In some embodiments, the application of a convex vibration detection unit allows for less interference between the vibration detection units in an array. In some embodiments, the application of an inverse mesa vibration detection unit allows for less interference between the vibration detection units in an array. With such configurations, it becomes possible to reduce and/or prevent interference between vibration detecting units in an array, including aspects such as propagation and/or reflection. In some embodiments, a convex vibration detecting unit has part of its vibrating mass distributed in a middle portion of the resonator, so that vibration energy is constrained closer to the middle portion of the unit. As such, there can be a greater interference prevention effect as this section is more isolated. Similarly, the additional structure of the inverse mesa arrangement allows for less interference between the various vibration detecting units. In addition, as the size and area of the sensor become smaller, the distance between resonators becomes shorter, so that there is a greater interference prevention effect.

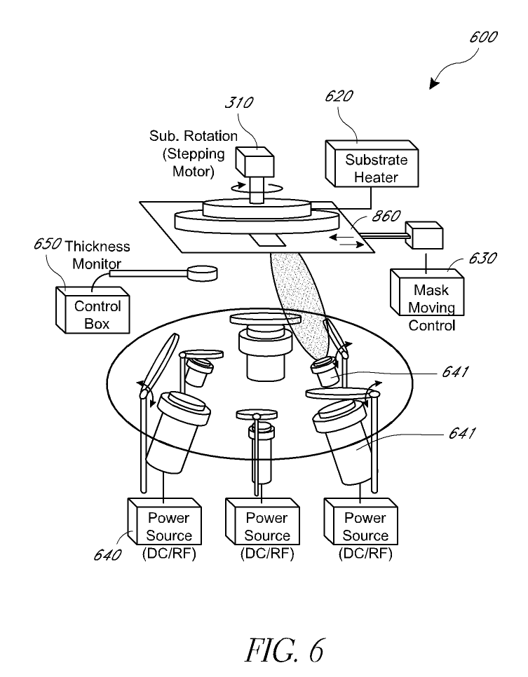

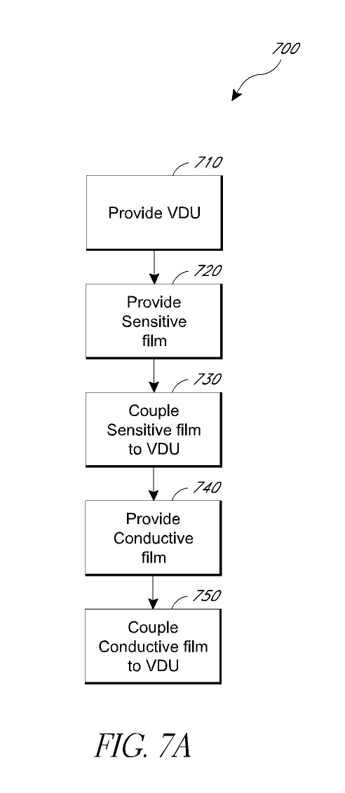

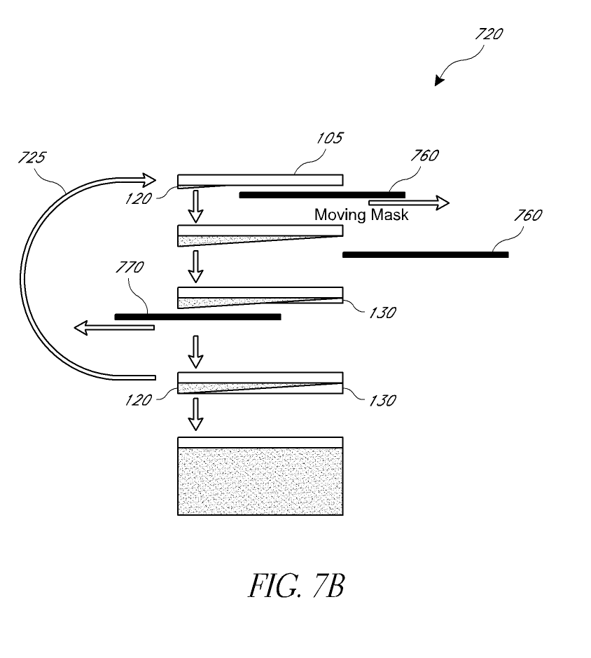

The various embodiments provided herein can be manufactured in any of a number of ways. The sensitive films can be provided by combinatorial pulse laser deposition (PLD), sputtering, and/or chemical vapor deposition (CVD), for example. FIG. 6 depicts some embodiments of a system for manufacturing a sensor device that includes a graded sensitive film via PLD. The system 600 can include a motor 610, a substrate temperature control unit 620, a mask 860, a mask moving control 630, one or more lasers or light sources 641, one or more power sources 640 for powering the lasers or light sources, and a film thickness monitor 650. FIG. 7A depicts some embodiments of a method of manufacturing a sensor device including a graded sensitive film as described herein. In some embodiments, the method includes but is not limited to providing a vibration detecting unit (block 710) and providing a sensitive film (block 720). In some embodiments, one can couple the sensitive film to the vibration detecting unit (block 730). In some embodiments, coupling can be achieved by depositing the sensitive film onto the vibration detecting unit. The method can further include providing a conductive film (block 740). The conductive film is coupled to the vibration detecting unit (block 750). In some embodiments, the coupling can be achieved by depositing the conductive film onto the vibration detecting unit.

FIG. 7B is a schematic illustrating of some embodiments of a method of providing a graded sensitive film (for example, in block 720). As noted above, in some embodiments, the film can be formed by means of combinatorial pulse laser deposition (PLD), sputtering, or CVD. FIG. 7B depicts an embodiment employing a mask, and for demonstration purposes only, the system of FIG. 6. As depicted in FIG. 7B, in some embodiments, a first sensitive film 120 is deposited while moving a mask 760 from a first vertex of the substrate. A second sensitive film 130 is deposited while moving a mask 770 (which can be the same or a different mask) from a second vertex of the substrate over the first graded sensitive film 120. The process can be repeated 725 as many times as desired to provide additional sensitive films (for example, see FIG. 4B).

In some embodiments, it is possible to change the gradient and/or thickness of each sensitive film (component) by changing the mask movement speed and/or the film formation rate for each sensitive film.

The film formation rate can be any rate suitable for forming the desired thickness or gradient of the film. In some embodiments, the film formation rate can be 1 nm/sec or less, for example, 0.5, 0.05, 0.03, 0.02, 0.01, 0.001 nm/sec or less, including any range above or below any one of the preceding values and any range defined between any two of the preceding values. As will be appreciated by those of skill in the art, the film formation rate can also depend on the conditions of the film formation technique. For example, the film formation rate can depend on a gas flow rate, temperature, and/or pressure. It will also be appreciated that as the size of the sensor device (and the sensitive film) is reduced, there can be an increase in the non-uniformity in the amount of material applied for the formation of the sensitive film. In some embodiments, a single sensitive film can be provided over multiple vibrational detecting units.

In some embodiments, convex vibration detecting units have raised portions on their surfaces. In some embodiments, inverse-mesa vibration detecting units have recesses on their surfaces. In some embodiments, the vibration detecting units are quartz crystal microbalances.

In some embodiments, a graded-composition film structure is a film structure in which the composition of multiple components is graded by varying their thicknesses so that varying functions will be exhibited as a result of a single film formation process.

In some embodiments, the devices and films provided herein can be formed by combinatorial film formation.

In some embodiments, by forming films on the substrate while finely modulating the physical properties that serve as parameters of the film materials, such as the polarity, dielectric constant, dissolution parameter, hydrophilicity, hydrophobicity, charge, and conductivity, it is possible, through vibration detection, to efficiently search for a material that will serve as a sensitive film that selectively responds to a specific gas component.

In some embodiments, the above sensitive films, devices and/or arrays are sized appropriately for use in a mobile device. In some embodiments, the application of a graded sensitive film allows one to avoid and/or minimize degraded detection precision and degraded reliability. In some embodiments, the array or device can be used to detect odors. In some embodiments, the array or device can be used to detect flatus. In some embodiments, the film layers are not formed by dipping. In some embodiments, the layers are not formed by spraying. In some embodiments, the sensitive film and/or device and/or array is part of a mobile device, such as a phone, laptop, breathalyzer, security wands, watch, tablet, PDA, smartphone, other handheld device, or wearable device (for example, wrist-wearable or head-wearable). In some embodiments, the device is part of a healthcare kit or medical device.

In some embodiments, the herein presented arrays, sensitive films and devices can be employed within devices for checking fluids such as liquids and gases for various targets. These devices can have a wide range of applications including environmental chemical monitoring, industrial process control, leakage tests, automobile discharge gas tests, disease diagnosis and health management, quality control through monitoring of food and drinking water, and military purposes such as detection of weapons or explosives.

In some embodiments, the graded sensitive film embodiments provided herein do not suffer from a reduced specific surface area for the sensitive portion. As such, unlike in other technologies, the signal intensity need not become weaker upon its use in a mobile device.

As will be appreciated from the disclosure herein, in some embodiments, one or more of the devices and methods provided herein can provide any number of advantages. In some embodiments, negative effects such as interference can be reduced. In some embodiments, it is possible to readily form an array using a graded-composition film structure involving multiple components. In some embodiments, even when the vibration detecting unit size is made small and the amount of applied sensitive film material accordingly becomes very small, it is possible to reduce non-uniformity in the amount of applied material among individual elements. In some embodiments, when the number of vibration detecting units in an array is increased, it is possible to simultaneously form films constituting a graded-composition film structure at individual vibration detecting units. Accordingly, in some embodiments, it is possible to manufacture a chemical sensor that allows precise and reliable detection and that is small enough to be installed in a mobile device.

### EXAMPLE 1

### Formation of a Sensor Device Having a Graded Composition Film Structure

The present example outlines how to prepare a graded layer for a sensor device.

A PMMA substrate (10mm×17.5 mm) with an array of 2 convex quartz crystal microbalances (as the vibration detecting units) having separate electrodes on a single face of each convex QCM was provided.

Zinc oxide (ZnO) and a titanium dioxide TiO₂ films were formed on the substrate. The ZnO (3N, Kojundo Chemical Lab) film was formed at a rate of 0.0312 nm/sec with a sputtering power of RF 150W. The TiO₂ (3N, Kojundo Chemical Lab) film was formed at a rate of 0.0183 nm/sec with a sputtering power of RF250W.

The films were formed using a combinatorial sputtering device (CMS-6400). Prior to film formation the following conditions were confirmed: base pressure: about 1.5×10⁻⁵ Pa; sputtering gas/flow rate: Ar/50 sccm; pressure during film formation: 0.7 Pa; substrate temperature and room temperature (about 25° C.).

The above process provided 30 layers, each layer composed of TiO₂ and ZnO, stacked. The total target thickness of the film was 150 nm. The present method was performed on a combinatorial sputtering apparatus (CMS-6400).

### EXAMPLE 2

### Sensor Device Including a Graded Composition Film Structure of Three Sensitive Films

The present example discloses methods for forming a sensor device.

A substrate having the shape of an equilateral triangle is placed in a film forming system. The substrate is made of PMMA with an array of fifteen inverse mesa vibration detecting units having separate electrodes to each vibration detecting unit.

A first graded sensitive film of acrylic acid is formed while moving a mask from a first vertex of the substrate. A second graded sensitive film of palladium is formed while moving a mask from a second vertex of the substrate. A third graded sensitive film of zinc oxide is formed while moving a mask from a third vertex of the substrate. The first, second and third vertices overlap to at least some extent. The vibration detecting units and various detection sites are arranged as provided in FIGS. 4C to 5B.

As the three films are graded and overlap to varying degrees the process provides a highly diversified mixture of the amount (including presence or absence) of each of the three film materials as one moves across the surface of the films. Thus, with the simple application of three different film materials, a significantly larger variety of detection sites is provided (6 as depicted in FIG. 5A, or 15 (as shown in 5B) if each specific vibration detection unit is considered).

### EXAMPLE 3

### Use of a Graded Sensor Device

The sensor device of Example 1 is provided and activated through the use of an electrical current. A baseline signal from the device is observed in the absence of any molecules in the environment that would otherwise bind to the sensitive film.

A sample of air to be tested is blown onto a surface of the sensitive film. The presence of hydrogen sulfide in the sample of air will associate with the ZnO film, changing the mass of the film, and altering the frequency of vibration of the film. This change in vibration is detected by the vibration detecting unit, and transmitted to a computer, or in the alternative, a display device, where the change in signal can be observed, thereby demonstrating the detection of the presence of hydrogen sulfide in the sample of air.

The presence of either a convex vibration detecting unit or an inverse mesa detection unit allows for a reduction in possible interference that could otherwise occur in the array.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

1. A sensor device, comprising:
at least one convex vibration detecting unit;
at least one conductive layer; and
at least one sensitive film associated with the at least one convex vibration detecting unit, wherein the at least one sensitive film is configured to detect a target molecule, wherein the at least one sensitive film includes a first end of a first thickness and a second end of a second thickness, wherein the at least one sensitive film is graded to vary in thickness from the first end to the second end.

2. The sensor device of claim 1, wherein the at least one convex vibration unit is one of a plurality of vibration detecting units.

3. The sensor device of claim 1, further comprising an equilaterally shaped substrate.

4. The sensor device of claim 1, wherein the at least one sensitive film comprises at least one of an acrylic acid, palladium, or zinc oxide.

5. The sensor device of claim 1, wherein the sensor device comprises at least two or more sensitive films.

6. The sensor device of claim 5, wherein the sensor device comprises at least three or more sensitive films.

7. The sensor device of claim 6, wherein at least two or more of the sensitive films overlap one another.

8. The sensor device of claim 6, wherein the at least two or more of the sensitive films overlap one another in an area over the at least one convex vibration detecting unit.

9. The sensor device of claim 1, wherein the at least one convex vibration detecting unit comprises a raised portion on a surface of the at least one convex vibration detecting unit.

10. The sensor device of claim 1, further comprising at least one electrode.

11. The sensor device of claim 10, wherein the at least one electrode comprises two separate electrodes.

12. The sensor device of claim 11, wherein the two separate electrodes are on a same face of the vibration detecting unit.

13. The sensor device of claim 10, wherein the at least one convex vibration detecting unit comprises:
at least one quartz support;
at least one conductive film on a top face of the quartz support; and
at least one excitation electrode on a bottom face of the quartz support.

14. The sensor device of claim 10, wherein the at least one electrode comprises an excitation electrode.

15. The sensor device of claim 14, wherein the at least one excitation electrode comprises at least one of a pair of separated electrodes having an electrode gap or a non-separated electrode.

16. A sensor device, comprising:
at least one inverse mesa shaped vibration detecting unit;
at least one sensitive film associated with the at least one inverse mesa shaped vibration detecting unit, wherein the at least one sensitive film is configured to detect a target molecule, wherein the at least one sensitive film includes a first end of a first thickness and a second end of a second thickness, wherein the at least one sensitive film is graded to vary in thickness from the first end to the second end; and
at least one conductive film associated with the at least one sensitive film.

17. The sensor device of claim 16, wherein the at least one inverse mesa shaped vibration unit is one of a plurality of vibration detecting units.

18. The sensor device of claim 16, further comprising an equilaterally shaped substrate.

19. The sensor device of claim 16, wherein the at least one sensitive film comprises at least one of an acrylic acid, palladium, or zinc oxide.

20. The sensor device of claim 16, wherein the sensor device comprises at least two or more sensitive films.

21. The sensor device of claim 20, wherein the sensor device comprises at least three or more sensitive films.

22. The sensor device of claim 21, wherein at least two or more of the sensitive films overlap one another.

23. The sensor device of claim 22, wherein the at least two or more of the sensitive films overlap one another in an area over the at least one inverse mesa shaped vibration detecting unit.

24.-31. (canceled)

32. A sensor device, comprising:
at least one vibration detecting unit;
at least one conductive layer; and
at least two or more sensitive films comprising:
a first sensitive film associated with the at least one vibration detecting unit, wherein the first sensitive film is configured to detect a first target molecule, wherein the first sensitive film is graded to vary in thickness, wherein the first sensitive film has a first thickness in a first area and a second thickness in a second area; and
a second sensitive film associated with the at least one vibration detecting unit, wherein the second sensitive film is configured to detect a second target molecule, wherein the second sensitive film is graded to vary in thickness, wherein the second sensitive film has a third thickness in the first area and a fourth thickness in the second area, wherein the first thickness is greater than the third thickness, and wherein the fourth thickness is greater than the second thickness.

33. The sensor device of claim 32, wherein the at least two or more sensitive films overlap one another in an area over the at least one vibration detection unit to facilitate the detection of one or more target molecules.

34. The sensor device of claim 32, wherein the second target molecule is the same as the first target molecule.

35. The sensor device of claim 32, wherein the second target molecule is different from the first target molecule.
